(19) United States
(12) Patent Application Publication
(10) Pub. No.: US 2009/0132998 A1
(43) Pub. Date: May 21, 2009

(54) DEBUGGING MULTI-EXECUTION ENVIRONMENT APPLICATIONS

(75) Inventors: Henricus Johannes Maria Meijer, Mercer Island, WA (US); Brian C. Beckman, Newcastle, WA (US); Jeffrey van Gogh, Redmond, WA (US); Bruno S. Bozza, Redmond, WA (US); Wei Zhu, Sammamish, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/941,638

(22) Filed: Nov. 16, 2007

(51) Int. Cl. G06F 9/44

(52) U.S. Cl. 717/124

(57) ABSTRACT

A framework is provided that allows for debugging of applications/systems that execute in multiple execution environments. Instead of using the native application programming interface to interact with an execution environment, an alternative implementation of at least some of the application programming interface of the native execution environment is employed to facilitate debugging in a disparate execution environment.

### TECHNICAL FIELD

The subject disclosure relates to debugging software, and more particularly to debugging applications that execute in different execution environments and/or applications that have been cross-compiled to execute in a different execution environment.

### BACKGROUND

Complex distributed applications are constantly being developed that execute in different execution environments. For example, in a typical Asynchronous JavaScript and XML (AJAX) application, client-side Javascript executes in the browser and communicates with one or more server applications running in a different execution environment, such as a Java Virtual Machine or a Common Language Runtime. During execution, the client-side Javascript can make a number of asynchronous calls to the server application to receive small amounts of data.

Debugging these AJAX applications is extremely complex for a number of reasons. The asynchronous nature of calls to the server frustrates the use of standard debugging techniques. In addition, programmers responsible for developing these applications often lack experience in developing and debugging in at least one of the multiple execution environments and/or the programming languages associated with those environments.

Furthermore, there are significant differences between the types of programming languages used on the client-side and the server-side. Programming languages used in the browser are typically interpreted languages, such as Javascript, that lack language features such as strong typing to catch errors. Many times full-fledged debuggers are not available for these languages. Programming languages used on the server-side, on the other hand, are typical compiled to run on a real or virtual machine and have numerous features, such as type checking, to find errors. In light of the differences in the programming languages, it is often not possible to use the same debugging tools to debug both portions of the code and frequently the debuggers available for programming languages used in the browser are suboptimal.

The above-described deficiencies of debugging distributed applications are merely intended to provide an overview of some of the problems of today's debugging techniques, and are not intended to be exhaustive. Other problems with the state of the art can become further apparent upon review of the description of various non-limiting embodiments of the invention that follows.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the disclosed subject matter in a simplified form as a prelude to the more detailed description of the various embodiments of the disclosed subject matter that follows.

Briefly stated, an alternative implementation is generated to match at least a portion of a foreign execution environment, such as client-side Javascript. Unlike a native implementation of the foreign execution environment, the alternative implementation runs in another execution environment which facilitates the use of a debugger associated with that execution environment. Thus, it can be debugged using features, such as strong typing, available in that execution environment. In addition to executing instructions that perform the same function as the native implementation, the alternative implementation can perform various management functions, such as marshaling types and values as needed to simulate the native environment application programming interface or maintaining weak references to facilitate garbage collection can be performed.

Alternative implementations can be generated/implemented in various manners. For example, in some embodiments, at least a portion of the alternative implementation can be automatically created using foreign objects/foreign function metadata. Objects, such as browser components, can be wrapped so as to implement the functionality of the alternative implementation.

In at least some embodiments, the use of the alternative implementation is facilitated via a helper component. The helper component can, for example, produce instances of wrapped objects on which the alternative implementation operates. An Integrated Development Environment (IDE) can facilitate the use of the helper component by automatically invoking it and associating a debugger when the application is run in debug mode.

The following description and the annexed drawings set forth in detail certain illustrative aspects of the disclosed subject matter. These aspects are indicative, however, of but a few of the various ways in which the principles of the innovation can be employed and the disclosed subject matter is intended to include all such aspects and their equivalents. Other advantages and distinctive features of the disclosed subject matter will become apparent from the following detailed description of the innovation when considered in conjunction with the drawings.

### BRIEF DESCRIPTION OF THE DRAWINGS

The system and methods for debugging are further described with reference to the accompanying drawings.

FIG. 1 is a block diagram of an application/system that runs in multiple execution environments.

FIG. 2 is a block diagram of a manner in which an application/system that can be debugged using the disclosed techniques is developed according to one embodiment.

FIG. 3 illustrates an exemplary system according to one embodiment.

FIG. 4 illustrates various considerations that are taken into account when developing the alternative implementation according to one embodiment.

FIG. 5 illustrates exemplary execution environments and an alternative implementation according to one embodiment.

FIG. 6 is a flowchart of generating the alternative implementation according to one embodiment.

FIGS. 7A-7B are flowcharts for debugging using the library according to one embodiment.

FIG. 8 is a block diagram representing an exemplary non-limiting computing system or operating environment in which the disclosed subject matter can be implemented.

### DETAILED DESCRIPTION

As used herein, when reference is made to a particular programming language, various commercially-available/publicly-available implementations of that programming language are intended to be included within that meaning, regardless of whether an implementation complies with a standard associated with that language, has non-standard language extensions, was acquired from an organization other than the trademark holder associated with that programming language, was ported to another platform/computing environment, or has any other modifications/enhancements to the language or associated software (e.g., compiler, interpreter, preprocessor, etc.). For example, when “Javascript” is used herein, it refers not only to Javascript implementations in Netscape/Mozilla-based browsers, but Jscript® from Microsoft (e.g., in Internet Explorer®), and Javascript implementations from Adobe or Opera.

As used herein, an execution environment is an environment in which instructions are executed/interpreted to perform an action. Execution environments, can include, but are not limited to: virtual machine environments, such as a Java Virtual Machine, Parrot, or the Common Language Runtime; native environments, such as native machine instructions; a component object model environment, such as COM and XPCOM; or a scripting environment, such as JavaScript or VBScript. One will appreciate that the execution environments can be context-dependent, such as treating scripting environments differently depending on where the scripts are executed (e.g., web browser vs. server-side vs. specific application software).

Often an execution environment will have one or more programming languages associated with it (e.g., Java with the Java Virtual Machine, or C# and Visual Basic on the Common Language Runtime) although some programming languages can be compiled/interpreted to result in code that operates in more than one execution environment (e.g., C++ to COM and native computer instructions). One will appreciate that disparate execution environments can refer to two different types of execution environments (e.g., scripting and virtual machine environments) or can include different versions of the same execution environment.

Each execution environment can have one or more application programming interfaces (APIs) associated with it. These APIs can be part of the execution environment itself (e.g., named interfaces of a component object model) or APIs of a programming language associated with the execution environment.

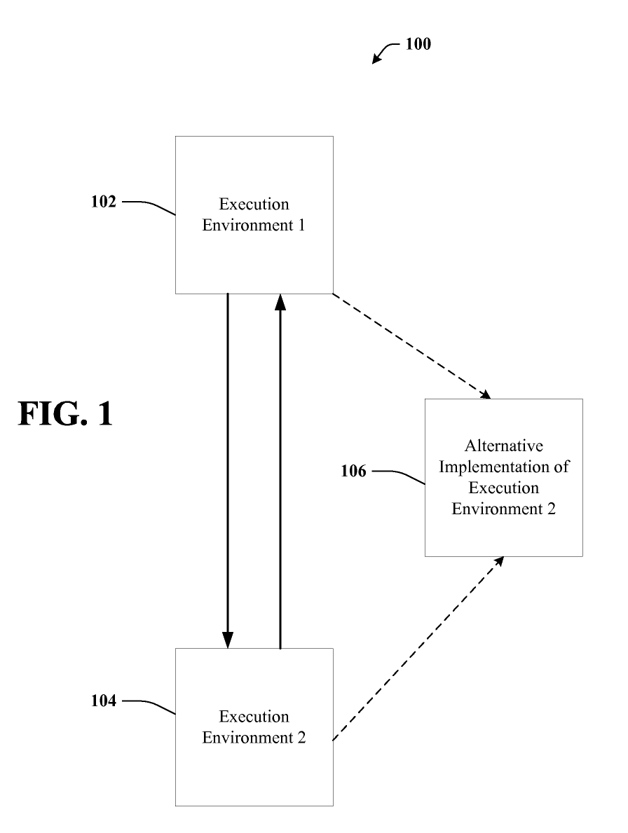

Referring initially to FIG. 1, a typical multi-execution environment application/system 100 is illustrated. In production (e.g., non-debug) use, the application can be executed in two separate execution environments (102 and 104), such as one on the client-side and one server-side. One will appreciate, however, that multi-execution environment application/system are not always distributed applications. These environments can, for example, represent, language pairs: JavaScript and Java, JavaScript and PHP, JavaScript and Perl, or Python and C. Although only two actual execution environments are shown for the sake of clarity, one will appreciate an application can use more that two execution environments.

The two execution environments can communicate with each other using various remote procedure calls or inter-process communication techniques known in the art. In one example, one environment makes calls to the other one via a foreign function interface.

When debugging such an application according to one aspect, an alternative implementation 106 of at least one of the application programming interfaces of execution environment can be utilized to facilitate debugging. The alternative implementation of the application programming interface of execution environment 2 (104) can be used to execute code in a programming language associated with environment 2, as well as in some embodiments by execution environment 1 102 so that the entire application runs under the same execution environment.

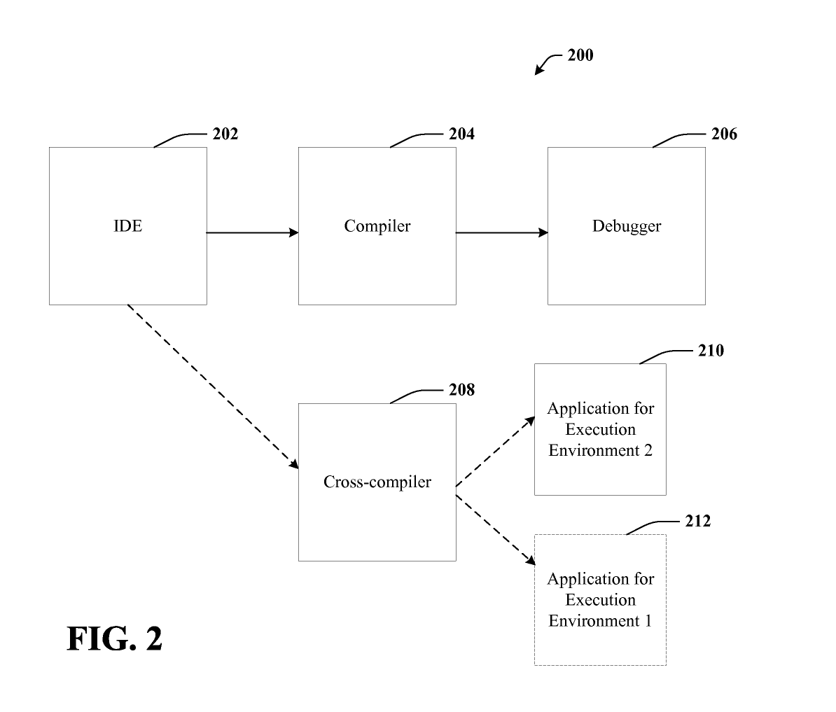

FIG. 2 illustrates a block diagram 200 of producing an application that can be debugged using the disclosed techniques according to one embodiment. A developer can use an Integrate Development Environment (IDE) to edit source code that is compiled using a compiler 204. Once the application is built, it can be debugged using a debugger 206. As used herein, “debugger” can include any debugging tool including any code analysis done by the compiler at compile time. One will appreciate that although a compiler is illustrated, a translator or other program that manipulates source code for execution can alternatively be utilized.

After the developer has initially debugged the application in a single execution environment, the developer can use a cross-compiler to generate source code (e.g., the source of application for execution environment 2 210) for a different execution environment, as well as optionally keeping source code for execution in the initial execution environment 212. The generated source of application 210 can then be debugged by an alternative implementation of at least one API of execution environment 2.

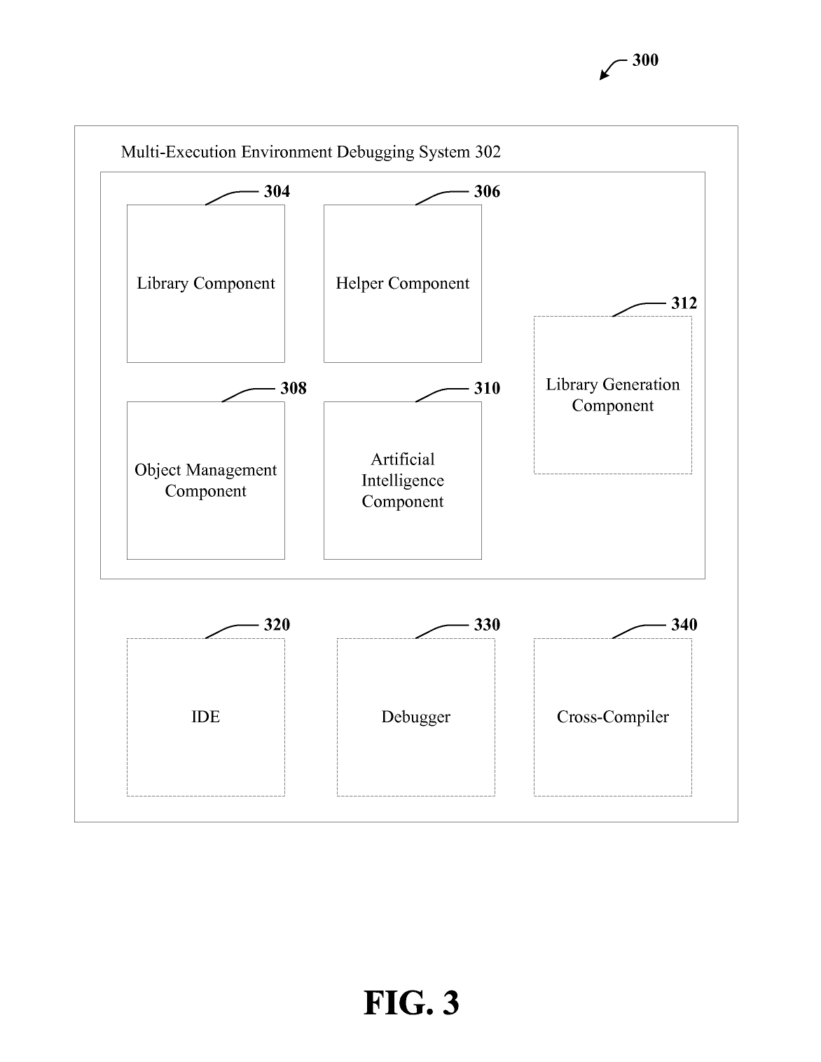

Referring to FIG. 3, a system 300 according to one embodiment is illustrated. The illustrated system 300 comprises a Multi-Execution Environment Debugging System 302 along with other components that facilitate the use of that system. A library component 304 provides an alternative implementation of at least one application programming interface of an execution environment so as to facilitate debugging using a debugger of a different execution environment. Helper component 306 employs the library component 304 to facilitate debugging. In particular, the helper component can provide a hosting environment and create instances of any objects used by the alternative implementation. The helper component 306 can be a portion of code or a helper application in some embodiments. Object management component 308 can perform caching of objects/memory and management of the lifetimes of objects using weak references to facilitate garbage collection (if supported) by one of the execution environments.

An artificial intelligence component 310 can use artificial intelligence to infer various bugs and create warnings. The artificial intelligence component can use probabilistic and statistical models to infer actions to be performed (e.g., garbage collection of unused objects). The artificial intelligence component 310, for example, can also scan function calls and property requests to detect possible incompatibles between actual execution environments (e.g., different Javascript environments betweens browsers and browser versions). In addition, artificial intelligence can be used to detect the correct data type for a value when it is ambiguous (e.g., a value of “3”) or used as part of dataflow analysis of the code being executed. The artificial intelligence component can use Bayesian models, fuzzy logic, classifiers, etc.

The library generation component 312 facilitates creation of the library component 304. This component can be used, for example, by an organization that implements the alternative implementation and can be kept internally within that organization while still supplying the some or all of the other components to other organizations to facilitate their debugging needs. The library generation component can automatically create some or all of the alternative implementation based on metadata about the functions it is trying to emulate and metadata of objects/functions available to provide similar functionality. However, since some functions/objects do not map directly between languages, some functions are manually implemented by a developer.

Other components facilitate the use of the Multi-Execution Environment Debugging System 302. An IDE 320 can launch the helper component 306 as well as determine whether or not an application should run in debug mode. The debugger 330 can debug an application for a particular execution environment. The cross-compiler 340 can create the source code that is being debugged by the Multi-Execution Environment Debugging System.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, may be provided to communicatively couple to such sub-components in order to provide integrated functionality. Any components described herein can also interact with one or more other additional components.

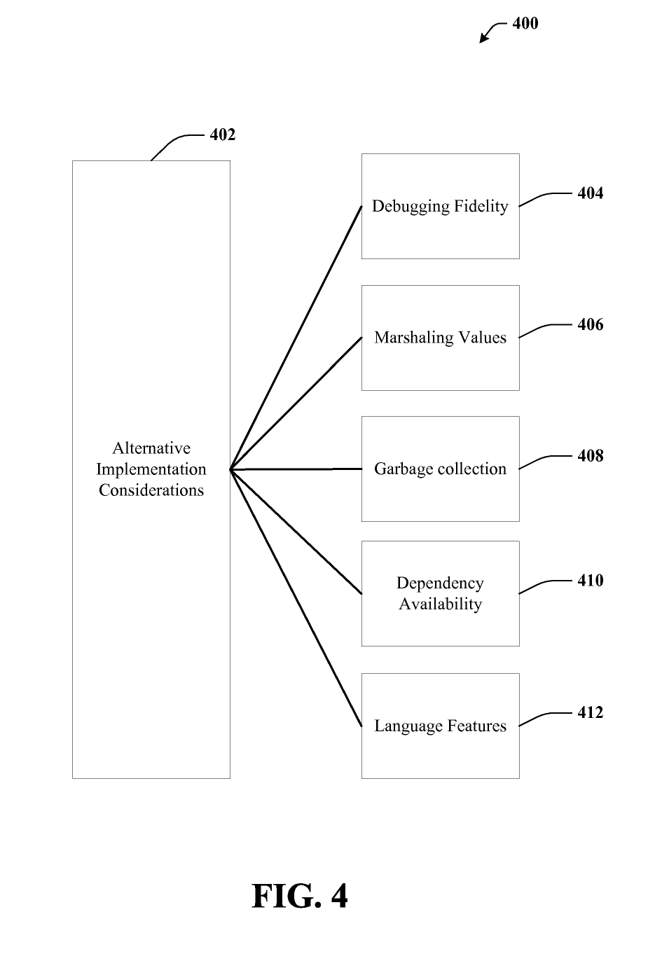

FIG. 4 illustrates a number of alternative implementation considerations that can be taken into account when creating the alternative implementation to facilitate debugging. In particular, debugging fidelity 404 should be maintained, such that if there is a bug when executing the code in the real execution environment, then the bug occurs in the alternative implementation. As a result, particular care needs to be taken to features that frustrate debugging fidelity, such as implementations that ignore execution environment features that are present in the real environment and not in the execution environment of the alternative implementation, or vice versa. For example, care can be taken when the same basic type of execution environment (e.g., Javascript/ECMAScript) can vary between different provider's implementations.

Marshaling values 406 is an additional consideration when creating the alternative implementation. The data types between the environments can be different and it is important to cast parameters to their correct data type when exchanging between execution environments. Values can be passed by reference or value. Garbage collection 408 of objects can be taken into account if one of the execution environments supports it. The alternative implementation can, for example, maintain weak references to manage the lifetime of objects/memory in each of the execution environments.

In some embodiments, the availability of dependencies 410 used in the alternative implementation should be taken into consideration. Thus, when one or more objects are wrapped to create an alternative implementation, it is important to consider whether those objects (or the correct version) are present on other machines that may use the implementation. Various other language features 412 can also be taken into account. Language features can include the availability of reflection or callbacks.

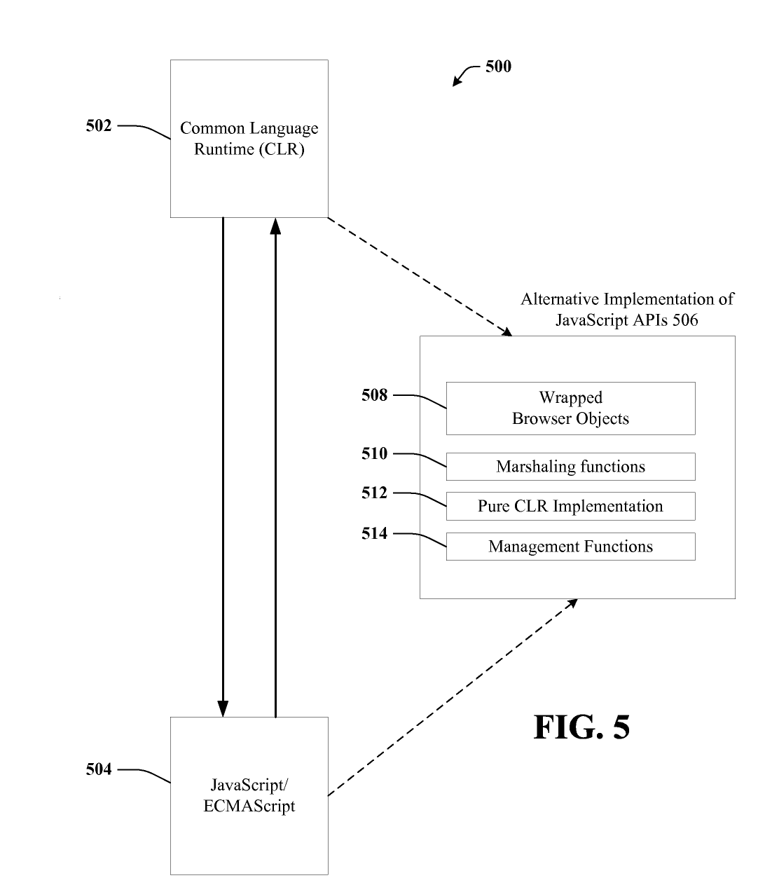

Referring to FIG. 5, a more concrete example of a multi-execution environment application/system 500 according to one embodiment is illustrated. In this illustrated scenario, the first execution environment is the Common Language Runtime (CLR) 502 and this runs on the server and communicates with Javascript/ECMAscript 504 executing in a web browser. In order to assist in debugging Javascript (and other associated files, such as XML/HTML files), an alternative implementation of the JavaScript APIs 506 is created that can execute in the Common Language Runtime environment 502.

The alternative implementation in this example, advantageously, uses one or more wrapped browser objects, such as wrapped COM objects from MICROSOFT INTERNET EXPLORER or XPCOM objects from Mozilla-based browsers. As previously mentioned, instances of these objects can be created using a helper application. In addition to the wrapped browser objects, a pure CLR implementation 512 can be created for functions/objects that are unable to be mapped between the environments automatically or semi-automatically, such as JavaScript's setTimeout( ) function. Moreover, the alternative implementation also includes marshaling function that marshal values/data types between the execution environments. Other management functions 514 are also implemented to maintain debugging fidelity. These management functions 512 can include caching the wrapped objects for faster access, maintaining object identity, or maintaining weak references to facilitate garbage collection.

Although web applications (e.g., applications developed using AJAX) are used as an exemplary multi-execution environment application in FIG. 5, one will appreciate that the techniques can facilitate debugging of any multi-execution environment application and is not limited to web applications, interpreted or scripting languages, or alternative implementations that use wrapped objects in a component object model.

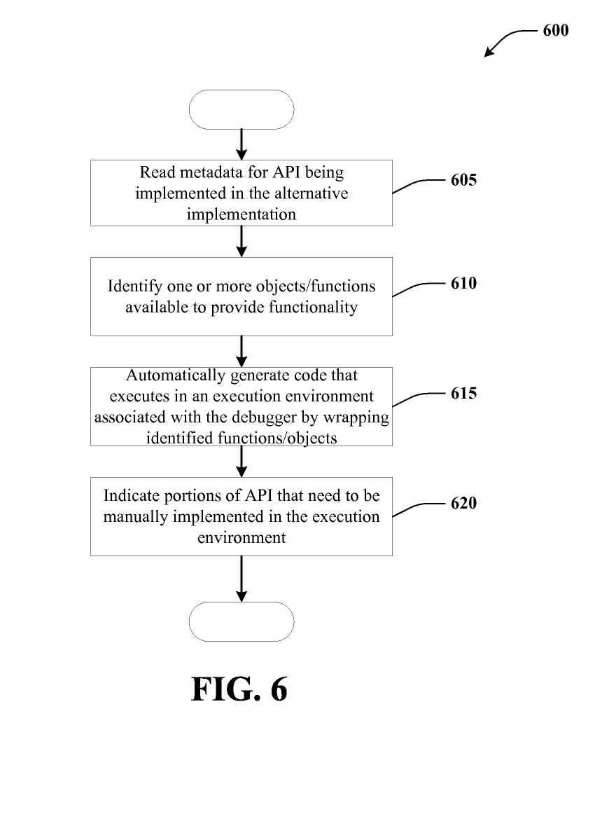

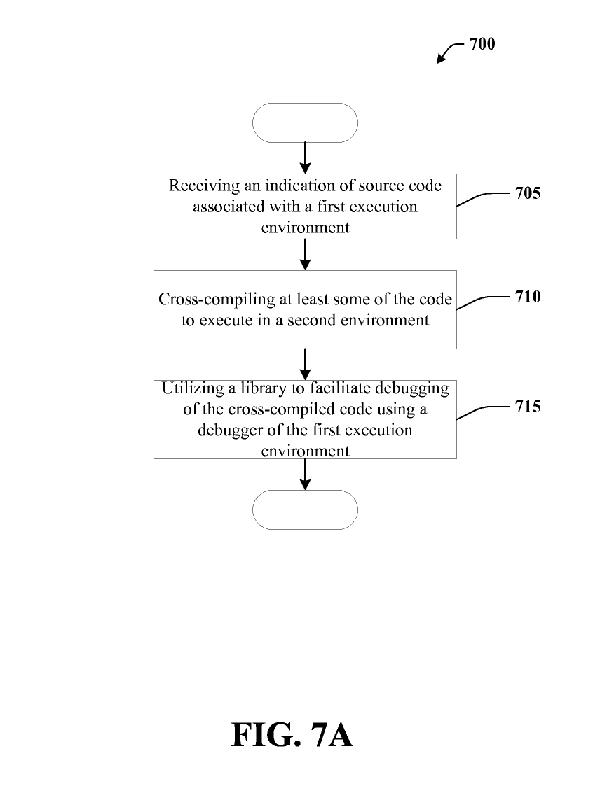

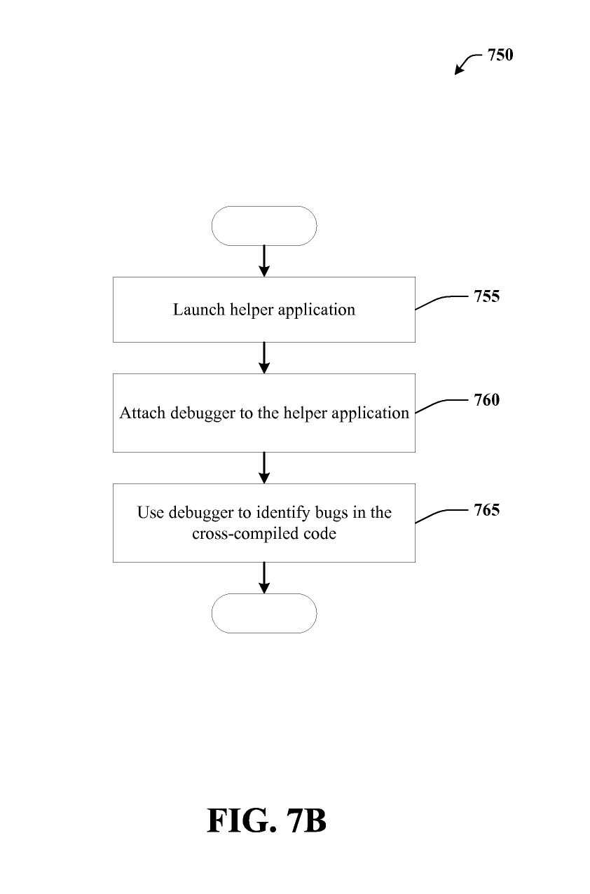

In view of the exemplary systems described supra, methodologies that can be implemented in accordance with the disclosed subject matter will be better appreciated with reference to the flowcharts of FIGS. 6 and 7A-7B. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks can be required to implement the methodologies described hereinafter.

Referring to FIG. 6, an exemplary method of generating the alternative implementation according to one embodiment is illustrated. At 605. the metadata for an API being implemented in the alternative embodiment is read. This metadata can be the foreign function interfaces or properties for the API although other forms of metadata can be read, such as via using reflection if supported by the execution environment. At 610, any functions/objects that can provide similar functionality to the API being alternatively implemented are identified. At 615, code is generated that executes in an execution environment associated with the debugger by wrapping the identified functions/objects. In addition, code can be generated for marshaling values between the two execution environments, as well as performing various other management activities (e.g., weak reference management, caching of the objects, etc.) Afterwards, at 620, portions of the API that could not be automatically implemented are indicated so that those portions can be manually implemented. For example, the Javascript version of setTimeout( ) function is not able to be automatically created via a wrapped object so it can be implemented manually in, for example, the Common Language Runtime using a .NET timer object. After these are manually implemented (and the alternative implementation itself debugged), it can be used to debug a multi-execution environment application/system or an application that has been cross-compiled to produce code for execution in another execution environment.

FIG. 7A illustrates debugging of cross-compiled source code according to one embodiment. At 705, an indication can be received of source code associated with the first execution environment. At 710, at least some of the code can be cross-compiled to execute in the second execution environment. In at least some embodiments, all of the code is cross-compiled while in other embodiments only a client-side portion of the code is cross-compiled. At 715, a library that provides an alternative implementation of the application programming interface of the execution environment can be utilized to facilitate debugging using a debugger of the first execution environment.

In particular, FIG. 7B illustrates an exemplary method of utilizing the library to facilitate debugging according to one embodiment. At 755, a helper application or helper code (not shown) can be launched, such as automatically by an IDE when the code is being executed in debug mode. At 760, a debugger can be attached to the helper application. At 765, the debugger can be used to identify bugs in the cross-compiled code.

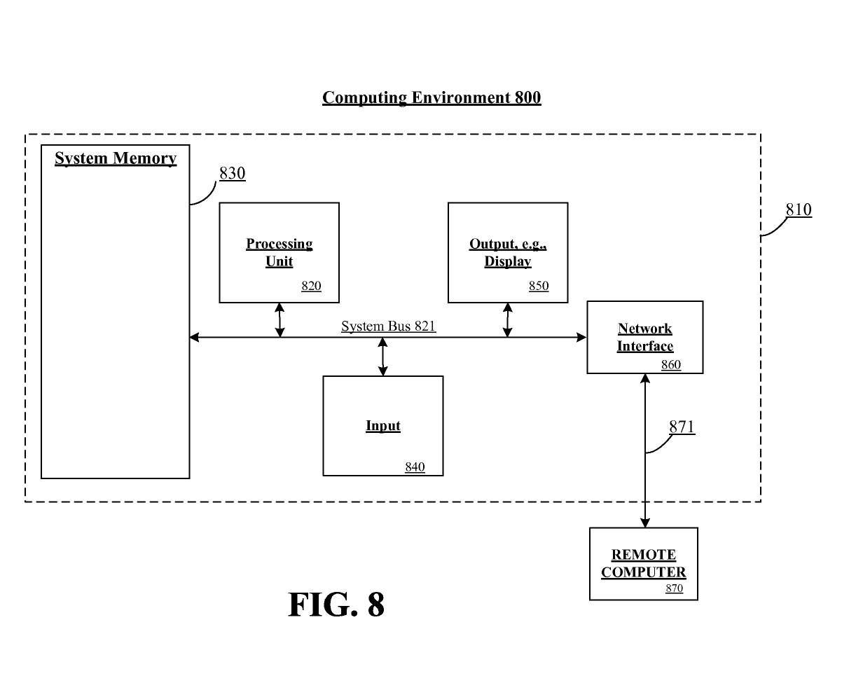

The invention applies to any device wherein it may be desirable to debug programs. It should be understood, therefore, that handheld, portable and other computing devices and computing objects of all kinds are contemplated for use in connection with the disclosed subject matter. Accordingly, the below general purpose remote computer described below in FIG. 8 is but one example, and the present invention may be implemented with any client having network/bus interoperability and interaction.

FIG. 8 thus illustrates an example of a suitable computing system environment 800 in which the invention can be implemented, although as made clear above, the computing system environment 800 is only one example of a suitable computing environment for a media device and is not intended to suggest any limitation as to the scope of use or functionality. Neither should the computing environment 800 be interpreted as having any dependency or requirement relating to any one or combination of components illustrated in the exemplary operating environment 800.

With reference to FIG. 8, an exemplary device for implementing the invention includes a general purpose computing device in the form of a computer 810. Components of computer 810 can include, but are not limited to, a processing unit 820, a system memory 830, and a system bus 821 that couples various system components including the system memory to the processing unit 820. The system bus 821 can be any of several types of bus structures including a memory bus or memory controller, a peripheral bus, and a local bus using any of a variety of bus architectures.

Computer 810 typically includes a variety of computer readable media. Computer readable media can be any available media that can be accessed by computer 810. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a modulated data signal such as a carrier wave or other transport mechanism and includes any information delivery media.

The system memory 830 can include computer storage media in the form of volatile and/or nonvolatile memory such as read only memory (ROM) and/or random access memory (RAM). A basic input/output system (BIOS), containing the basic routines that help to transfer information between elements within computer 810, such as during start-up, can be stored in memory 830. Memory 830 typically also contains data and/or program modules that are immediately accessible to and/or presently being operated on by processing unit 820. By way of example, and not limitation, memory 830 can also include an operating system, application programs, other program modules, and program data. One skilled in the art will also appreciate that more generally, memory can also include removable/non-removable, volatile/nonvolatile computer storage media.

Thus, computer 810 can also include other removable/non-removable, volatile/nonvolatile computer storage media. For example, computer 810 could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 821 through a non-removable memory interface such as an interface, and a magnetic disk drive or optical disk drive is typically connected to the system bus 821 by a removable memory interface, such as an IDE or SATA interface.

A user can enter commands and information into the computer 810 through input devices such as a keyboard and pointing device, commonly referred to as a mouse, trackball or touch pad. Other input devices can include a microphone, joystick, game pad, satellite dish, scanner, or the like. These and other input devices are often connected to the processing unit 820 through user input 840 and associated interface(s) that are coupled to the system bus 821, but can be connected by other interface and bus structures, such as a parallel port, game port or a universal serial bus (USB). A graphics subsystem can also be connected to the system bus 821. A monitor or other type of display device is also connected to the system bus 821 via an interface, such as output interface 850, which can in turn communicate with video memory. In addition to a monitor, computers can also include other peripheral output devices such as speakers and a printer, which can be connected through output interface 850.

The computer 810 can operate in a networked or distributed environment using logical connections to one or more other remote computers, such as remote computer 870, which can in turn have media capabilities different from device 810. The remote computer 870 can be a personal computer, a server, a router, a network PC, a peer device or other common network node, or any other remote media consumption or transmission device, and can include any or all of the elements described above relative to the computer 810. The logical connections depicted in FIG. 8 include a network 871, such local area network (LAN) or a wide area network (WAN), but can also include other networks/buses. Such networking environments are commonplace in homes, offices, enterprise-wide computer networks, intranets and the Internet.

When used in a LAN networking environment, the computer 810 is connected to the LAN 871 through a network interface or adapter. When used in a WAN networking environment, the computer 810 typically includes a communications component, such as a modem, or other means for establishing communications over the WAN, such as the Internet. A communications component, such as a modem, which can be internal or external, can be connected to the system bus 821 via the user input interface of input 840, or other appropriate mechanism. In a networked environment, program modules depicted relative to the computer 810, or portions thereof, can be stored in a remote memory storage device. It will be appreciated that the network connections shown and described are exemplary and other means of establishing a communications link between the computers can be used.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments have been described in connection with various computing devices and network architectures, the underlying concepts can be applied to any computing device or system in which it is desirable to quickly identify anomalies for further investigation by a human. For instance, the malicious behavior detection/prevention of the subject matter can be applied provided as a separate object on the device, as part of another object or system, as a distributed object, a combination of any of the foregoing, etc.

The various techniques described herein can be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component can be localized on one computer and/or distributed between two or more computers. Similarly, memory associated with one or more components can be localized to a process and/or thread of execution and/or distributed between two or more computers.

Thus, the methods and apparatus of the subject disclosure, or certain aspects or portions thereof, can take the form of program code (e.g., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, in particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as a computer-readable medium having computer-executable instructions for performing the acts and/or events of the various methods.

Additionally, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

While the disclosed subject matter has been described in connection with the preferred embodiments of the various figures, it is to be understood that other similar embodiments can be created or modifications and additions can be made to the described embodiment for performing the same function of the disclosed subject matter without deviating therefrom.

Still further, the present invention can be implemented in or across a plurality of processing chips or devices, and storage can similarly be effected across a plurality of devices. Therefore, the present invention should not be limited to any single embodiment, but rather should be construed in breadth and scope in accordance with the appended claims.

What is claimed is:

1. A system for debugging mixed execution environment applications, the system comprising;
a memory;
a library component that provides an alternative implementation of at least one application programming interface of a first execution environment so as to facilitate debugging using a debugger of a second disparate execution environment.

2. The system of claim 1 further comprising a helper component that employs the library component to facilitate debugging using the debugger of the second execution environment.

3. The system of claim 2 further comprising an integrated development environment that automatically launches the helper component and associates the debugger of the second execution environment with the helper component.

4. The system of claim 1 wherein the first execution environment is associated with Javascript.

5. The system of claim 1 wherein the second execution environment is at least one of Java or the Common Language Runtime (CLR).

6. The system of claim 1 wherein at least a portion of the library is automatically generated from foreign function interface metadata.

7. The system of claim 1 wherein the library performs at least one of marshaling argument types between types expected by the first execution environment and types received from the second execution environment, marshaling return types from the first execution environment to types expected by the second execution environment, or selectively marshaling values by reference.

8. The system of claim 1 further comprising an object management component that performs at least one of caching one or more objects used by the library so that instances of those objects can be reused or managing the lifetime of one or more objects using weak references to facilitate garbage collection.

9. The system of claim 1 further comprising a cross compiler that can translate code for the second execution environment to code for the first execution environment.

10. A method of debugging an application in a first execution environment for at least partial deployment in a disparate second execution environment, the method comprising:
receiving an indication of source code associated with the first execution environment;
cross-compiling at least some of the source code for execution in the second execution environment; and
utilizing a library to facilitate debugging of the code for execution in the second execution environment using a debugger for the first execution environment, the library providing an alternative implementation of at least one application programming interface of the second execution environment.

11. The method of claim 10 wherein the second execution environment is associated with an interpreted programming language.

12. The method of claim 10 wherein the utilizing of the library to facilitate debugging using a debugger of the first environment comprises launching a helper application.

13. The method of claim 10 wherein the first execution environment is a virtual machine environment.

14. The method of claim 10 wherein the library maintains weak references between objects in disparate execution environments to facilitates garbage collection.

15. The method of claim 10 wherein the library wraps one or more objects of a component object model that the first execution environment can interact with.

16. The method of claim 10 wherein at least a portion of the library was previously automatically generated based on metadata about the application programming interface.

17. The method of claim 10 wherein the first execution environment is a different version of the second execution environment.

18. A computer-readable storage medium comprising instructions for a library that provides an alternative implementation of at least one application programming interface of a first execution environment so as to facilitate debugging using a debugger for a second disparate execution environment.

19. The computer-readable storage medium of claim 18 further comprising instructions that when executed, performs the method comprising:
launching a helper application that employs the library to facilitate debugging.

20. The computer-readable storage medium of clam 19 wherein the launching of the helper application is performed automatically by an integrated development environment when an application is being run in debug mode.
